(19) United States
(12) Patent Application Publication
(10) Pub. No.: US 2010/0076148 A1
(43) Pub. Date: Mar. 25, 2010

(54) INK COMPOSITION

(75) Inventors: Naoya SHIBATA, Kanagawa (JP); Takafumi HOSOKAWA, Kanagawa (JP); Yoshimitsu ARAI, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/561,285

(22) Filed: Sep. 17, 2009

(30) Foreign Application Priority Data
Sep. 22, 2008 (JP) 2008-242048

(51) Int. Cl. C08L 33/12; C08L 39/04

(52) U.S. Cl. 524/548; 524/560

(57) ABSTRACT

The invention provides an ink composition containing at least: a pigment; one or more water-soluble organic solvent; a neutralizer; and water. At least a part of a surface of the pigment is coated with a copolymer containing at least a repeating unit represented by the following Formula (1) and a repeating unit having an ionic group. The one or more water-soluble organic solvents contains at least a water-soluble organic solvent having a solubility parameter value of 27.5 or less at a content of 90 weight % or more with respect to the total content of the one or more water-soluble organic solvents. In Formula (1), R¹ represents a hydrogen atom or a methyl group; L₁ represents a substituted or unsubstituted phenylene group; L₂ represents a single bond or a divalent linkage group; and Ar represents a monovalent group derived from: a condensed aromatic ring having 8 or more carbon atoms; a hetero ring containing condensed aromatic rings; or two or more linked benzene rings.

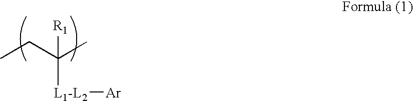

### CROSS-REFERENCE TO RELATED APPLICATION

This application claims priority under 35 USC 119 from Japanese Patent Application No. 2008-242048 filed on Sep. 22, 2009, the disclosure of which is incorporated by reference herein.

### BACKGROUND OF THE INVENTION

1. Field of the Invention

The invention relates to an ink composition.

2. Description of the Related Art

Various recording media for inkjet recording have been studied, and techniques for forming high-quality images are in demand. For inks for inkjet recording, coloring materials such as pigments have been studied as ink materials having resistance against water and/or light.

In particular, the performance of high quality printing at high-speed on plain paper (such as PPC paper sheet or non-coated printing paper) that is cheap and readily available is sought. Inhibition of plain paper from curling or cockling after printing when a water-soluble ink is used to print on plain paper is demanded.

Examples of a method to address this issue include use of an inkjet ink that contains a water-soluble solvent having a solubility parameter value (SP value) of from 16.5 to less than 24.6 at a content of 30% by weight or more based on the total amount of the ink, water at a content of from 10% by weight to less than 50% by weight based on the total amount of the ink, and a pigment dispersed by an alkali-soluble polymer dispersant (for example, see Japanese Patent Application Laid-Open (JP-A) No. 2007-145887).

### SUMMARY OF THE INVENTION

However, even the method described in JP-A No. 2007-145887 is not able to achieve image formation while also inhibiting formation of white spots in a recorded image.

The invention is achieved in view of the above circumstance. The invention provides an ink composition that is capable of inhibiting curling and formation of white spots in a recorded image, thereby providing an image with high definition.

Namely, one aspect of the present invention provides an ink composition comprising: a pigment; one or more water-soluble organic solvents; a neutralizer; and water, at least a part of a surface of the pigment being coated with a copolymer comprising a repeating unit represented by the following Formula (1) and a repeating unit having an ionic group, and the one or more water-soluble organic solvents comprising a water-soluble organic solvent having a solubility parameter value of 27.5 or less at a content of 90 weight % or more with respect to the total content of the one or more water-soluble organic solvents:

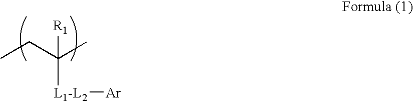

wherein R¹ represents a hydrogen atom or a methyl group; L₁ represents a substituted or unsubstituted phenylene group; L₂ represents a single bond or a divalent linkage group; and Ar represents a monovalent group derived from: a condensed aromatic ring having 8 or more carbon atoms; a hetero ring containing condensed aromatic rings; or two or more linked benzene rings.

### DETAILED DESCRIPTION OF THE INVENTION

The ink composition of the invention, that may be simply referred to as “ink” or “aqueous ink” hereinafter, contains at least a pigment; one or more water-soluble organic solvent; a neutralizer; and water. At least a part of a surface of the pigment is coated with a copolymer containing at least a repeating unit represented by Formula (1) and a repeating unit having an ionic group. The one or more water-soluble organic solvents contains at least a water-soluble organic solvent having a solubility parameter value of 27.5 or less at a content of 90 weight % or more with respect to the total content of the one or more water-soluble organic solvents. The ink composition of the invention may further contain other components such as a resin particle, a polymer latex or a surfactant if necessary.

This configuration may facilitate to provide an ink composition of the invention that is capable of inhibiting curling and formation of white spot in a recorded image to provide an image with high definition.

In the invention, the dispersion stability of the pigment in the ink may be drastically improved by having, in the liquid of the ink composition, the pigment contained as a coloring agent be in a state coated with a copolymer that contains the (a) repeating unit represented by Formula (1) and the (b) repeating unit having an ionic group, and formation of white spot in a recorded image may be inhibited by performing record on a recording medium with the ink.

That is, image failure such as the white spot caused by irregular ink jetting direction during ink ejection is inhibited from occurring and thereby a high definition image free from the white spot may be realized.

Water-Soluble Organic Solvent

The ink composition contains a water-soluble organic solvent for the purpose of inhibition of drying, wetting, acceleration of permeation and the like.

Specifically, when the ink composition is used in a form of a water-soluble ink composition in an inkjet recording method, the water-soluble organic solvent is suitable from the view point of obtaining a function such as a drying inhibitor, a wetting agent or a permeation accelerator.

The water-soluble organic solvent as the drying inhibitor and/or the wetting agent may be used for the purpose of inhibiting clogging of a nozzle due to drying of the ink composition at an ink jetting port of the nozzle. The water-soluble organic solvent which is expected to work as the drying inhibitor and/or wetting agent the preferably has the vapor pressure which is lower than water.

The water-soluble organic solvent may be preferably used as a permeation accelerator for the purpose of enhancing permeation of the ink composition (in particular, the ink composition prepared as an inkjet ink composition) into a paper.

The ink composition contains the water-soluble organic solvent having a SP value of 27.5 or less at a content of 90 weight % or more relative to the total amount of one or more water-soluble organic solvent(s) in view of suppressing curling.

When the ink composition of the invention contains two or more water-soluble organic solvents which respectively have a solubility parameter value of 27.5 or less, the sum of the contents of the two or more water-soluble organic solvents which respectively have a solubility parameter value of 27.5 or less is 90 weight % or more with respect to the total content of all of the water-soluble organic solvents contained in the ink jet recording liquid.

The SP value is preferably from 18 to 26.5, and more preferably from 20 to 23, from the viewpoint of improving the effect of inhibiting the curling. Examples of the water-soluble organic solvent having such a feature include a water-soluble organic solvent that contains a compound represented by the following Structural formula (1) and has the SP value of 27.5 or less.

The solubility parameter (SP value) of a water-soluble organic solvent in the invention is a value represented by a square root of molecular cohesive energy and may be calculated according to the method described in R. F. Fedors, Polymer Engineering Science, 14, pp. 147-154 (1974) (which is incorporated herein by reference in its entirety). In the invention, thus-obtained numerical value is adopted.

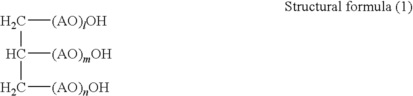

In Structural formula, l, m and n each independently represent an integer of 1 or more, and l+m+n=3 to 15. When l+m+n is 3 or greater, the curl suppressing effect can be sufficiently obtained. When l+m+n exceeds 15, inkjetting properties may be deteriorated. l+m+n is preferably 3 to 12, and more preferably 3 to 10.

In Structural formula (1), AO represents at least one of an oxyethylene group (EO) and an oxypropylene group (PO), and preferably an oxypropylene group. Each AO in (AO)l, (AO)m, and (AO)n may be the same or different.

Specific examples of the solvent having an SP value of 27.5 or less and the compound represented by Structural formula (1) are shown below; however, the present invention is not limited to these. SP values of the compounds are indicated in parentheses respectively.

Diethylene glycol monomethylether (DEGmEE, SP value: 22.4)
Diethylene glycol monobutylether (DEGmBE, SP value: 21.5)
Triethylene glycol monobutylether (TEGmBE, SP value: 21.1)
Dipropylene glycol monomethylether (DPGmME, SP value: 21.3)
Dipropylene glycol (DPG, SP value: 27.2)

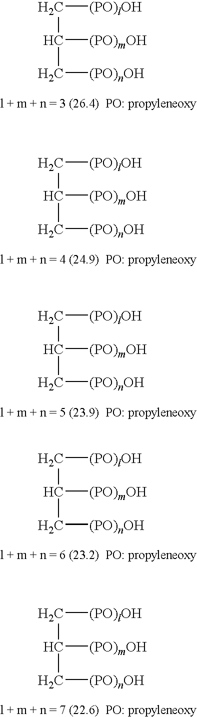

nC₄H₉O(AO)₄—H
(AO is EO or PO (the ratio of EO:PO=1:1)) (20.1)
   ✓ nC₄H₉O(AO)₁₀—H
(AO is EO or PO (the ratio of EO:PO=1:1)) (18.8)

HO(A′O)₄₀—H
(A′O is EO or PO (the ratio of EO:PO=1:3)) (18.7)

HO(A″O)₅₅—H
(A″O is EO or PO (the ratio of EO:PO=5:6)) (18.8)

HO(PO)₃—H (24.7)

HO(PO)₇—H (21.2)

1,2-hexanediol (27.4)

In the above formulae, EO represents an ethyleneoxy group, and PO represents a propyleneoxy group.

A solvent which is different from the solvent water-soluble organic solvent having an SP value of 27.5 or less may be further employed as long as the content of the water-soluble organic solvent having an SP value of 27.5 or less is kept at 90 weight % or more relative to the total amount of one or more water-soluble organic solvent(s).

Examples of a water-soluble organic solvent which can be additionally used as such other solvent include alkanediols (polyhydric alcohols) including glycerin, 1,2,6-hexanetriol, trimethylolpropane, and alkanediols such as ethyleneglycol, propyleneglycol, diethyleneglycol, triethyleneglycol, tetraethyleneglycol, pentaethyleneglycol, dipropyleneglycol, 2-butene-1,4-diol, 2-ethyl-1,3-hexanediol, 2-methyl-2,4-pentanediol, 1,2-octanediol, 1,2-hexanediol, 1,2-pentanediol, or 4-methyl-1,2-pentanediol; alkyl alcohols having 1 to 4 carbon atoms such as ethanol, methanol, butanol, propanol or isopropanol;

glycol ethers such as ethyleneglycol monomethyl ether, ethyleneglycol monoethyl ether, ethyleneglycol monobutyl ether, ethyleneglycol monomethyl ether acetate, ethyleneglycol mono-iso-propyl ether, ethyleneglycol mono-n-butyl ether, ethyleneglycol mono-t-butyl ether, diethyleneglycol mono-t-butyl ether, or 1-methyl-1-methoxybutanol; 2-pyrrolidone, N-methyl 2-pyrrolidone, 1,3-dimethyl-2-imidazolidinone, formamide, acetamide, dimethylsulfoxide, sorbit, sorbitan, acetin, diacetin, triacetin, and sulfolane. One or more among these solvents may be employed as the other solvent.

Examples of the other solvent further include so-called solid wetting agents including saccharides such as glucose, mannose, fructose, ribose, xylose, arabinose, galactose, aldonic acid, glucitol, maltose, cellobiose, lactose, sucrose, trehalose or maltotriose; sugar alcohols; hyaluronic acids; and ureas.

A polyhydric alcohol can be preferably employed as an anti-drying agent and/or a wetting agent. Examples of the polyhydric alcohol include glycerin, ethyleneglycol, diethyleneglycol, triethyleneglycol, propyleneglycol, dipropyleneglycol, tripropyleneglycol, 1,3-butanediol, 2,3-butanediol, 1,4-butanediol, 3-methyl-1,3-butanediol, 1,5-pentanediol, tetraethyleneglycol, 1,6-hexanediol, 2-methyl-2,4-pentanediol, polyethyleneglycol, 1,2,4-butanetriol, and 1,2,6-hexanetriol. One or more among these solvents may be employed as the other solvent.

A polyol compound can be preferably employed as a penetrating agent.

Examples of the polyol compound include aliphatic diols such as 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, 2-ethyl-1,3-hexanediol, or 2,2,4-trimethyl-1,3-pentanediol. Among these compounds, 2-ethyl-1,3-hexanediol and 2,2,4-trimethyl-1,3-pentanediol are preferable.

The water-soluble organic solvents may be used alone or in combination of two or more thereof.

The sum of the content(s) of the water-soluble organic solvent(s) in the ink composition is preferably from 1 to 60 weight %, more preferably from 5 weight % to 40 weight %, and particularly preferably from 10 weight % to 30 weight % with respect to the total amount of the ink composition from the viewpoint of obtaining stability and jetting stability.

Pigment Coated with Copolymer

The ink composition of the invention contains at least a pigment, that is coated with a copolymer which contains at least (a) the repeating unit represented by Formula (1) and (b) the repeating unit having an ionic group and may be referred to as a “resin-coated pigment” hereinafter.

The surface of the resin-coated pigment in the invention may be wholly or partially coated with the copolymer according to occasions.

(a) Repeating Unit Represented by Formula (1)

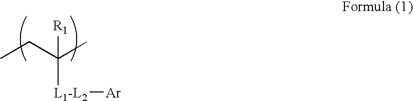

In Formula (1), R¹ represents a hydrogen atom or a methyl group; L₁ represents a substituted or unsubstituted phenylene group; L₂ represents a single bond or a divalent linkage group; and Ar represents a monovalent group derived from one of: a condensed aromatic ring having 8 or more carbon atoms; a hetero ring containing condensed aromatic rings; and two or more linked benzene rings.

The “group derived from one composition (, one monomer, or one structure)” herein means a group that has a structure which can be formed by removing at least one atom from the composition (, the monomer, or the structure).

In Formula (1), R¹ represents a hydrogen atom or a methyl group, and preferably represents a methyl group.

L₁ represents a substituted or unsubstituted phenylene group. In preferable embodiments, L₁ may be an unsubstituted phenylene group.

L₂ represents a single bond or a divalent linkage group. The divalent linkage group is preferably a linkage group having 1 to 30 carbon atoms, more preferably a linkage group having 1 to 25 carbon atoms, still more preferably a linkage group having 1 to 20 carbon atoms, and particularly preferably a linkage group having 1 to 15 carbon atoms.

In most preferable embodiments, L₂ may represent an alkyleneoxy group having 1 to 25 (more preferably 1 to 10) carbon atoms, an imino group (—NH—), a sulfamoyl group, a divalent linkage group containing an alkylene group such as an alkylene group having 1 to 20 (more preferably 1 to 15) carbon atoms or an ethylene oxide group [—(CH₂CH₂O)ₙ—, n=1 to 6], or combinations of at least two kinds thereof.

Ar represents a monovalent group containing one of: a condensed aromatic ring having 8 or more carbon atoms; a hetero ring containing condensed aromatic rings; and two or more linked benzene rings.

The “condensed aromatic ring having 8 or more carbon atoms” refers to a condensed aromatic ring having two or more benzene rings, or an aromatic compound having eight or more carbon atoms and including at least one aromatic ring and an alicyclic hydrocarbon condensed with the aromatic ring.

Specific examples thereof include naphthalene, anthracene, fluorene, phenanthrene, and acenaphthene.

The “hetero ring containing condensed aromatic rings” refers to a compound produced by condensation between an aromatic compound (preferably a benzene ring) containing no heteroatom, and a cyclic compound containing a heteroatom. The heteroatom-containing cyclic compound is preferably a five-membered or six-membered ring. The heteroatom is preferably a nitrogen atom, an oxygen atom, or a sulfur atom. The heteroatom-containing cyclic compound may contain plural heteroatoms. In this case, the plural heteroatoms may be the same or different from each other.

Specific examples of the hetero ring containing condensed aromatic rings include phthalimido, acridone, carbazole, benzoxazole, and benzothiazole.

The “two or more linked benzene rings” refers to a structure in which two or more benzene rings are linked via a single bond(s), a divalent linking group(s) or a trivalent linking group(s). Preferable examples of the divalent linking group include an alkylene group having 1 to 4 carbon atoms, —CO—, —O—, —S—, —SO—, —SO₂—, and a combination of any of these. Preferable examples of the trivalent linking group include a methine group.

The benzene rings in the two or more linked benzene rings may be linked with each other via plural linking groups, in which the plural linking groups may be the same structure or different from each other. The number of benzene rings contained in the two or more linked benzene rings is preferably 2 to 6, and more preferably 2 or 3. Specific examples of a structure contained in the two or more linked benzene rings include biphenyl, triphenylmethane, diphenylmethane, diphenyether, and diphenysulfone.

Specific examples of the monomer for forming the repeating unit represented by Formula (I) include the following monomers, although the invention is not limited by these.

M-25/M-27 (mixture of monomers M-25 and M-27, each of which having the substituent at m- or p-position)

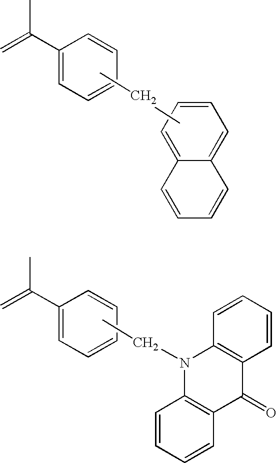

M-28/M-29 (mixture of monomers M-25 and M-27, each of which having the substituent at m- or p-position)

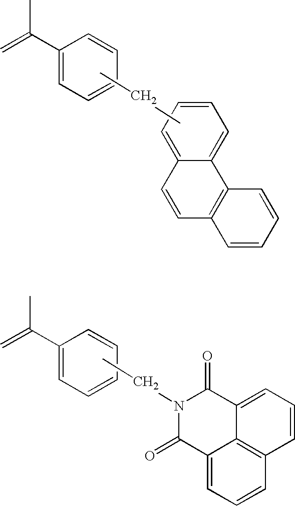

Mixture of the following two monomers, each of which having the substituent at m- or p-position

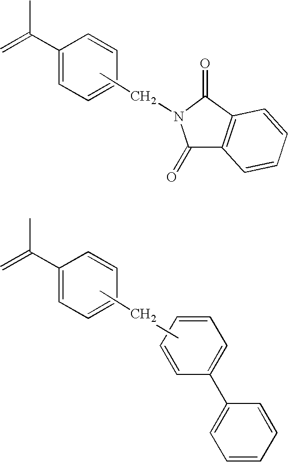

The Ar in the repeating unit represented by Formula (1) is preferably a monovalent group derived from acridone or phthalimide from the viewpoint of stability of the coated pigment.

The content of the repeating unit represented by Formula (1) is preferably is preferably from 5 weight % to 25 weight %, and more preferably from 10 weight % to 18 weight %, with respect to the total amount of the copolymer.

When the content is 5 weight % or more, occurrence of image defects such as white spot may be remarkably suppressed. When the content is 25 weight % or less, suitability to production of the copolymer may tend to be kept away from problems due to decrease of solubility of components in a polymerization reaction liquid such as methylethylketone.

(b) Repeating Unit Having Ionic Group

Examples of the (b) repeating unit having an ionic group include repeating units derived from a monomer having an ionic group such as a carboxyl group, a sulfo group, a phosphonate group or a hydroxy group. Specific examples thereof include vinyl monomers having an ionic functional group such as (meth)acrylates, (meth)acrylamides, and vinyl esters, each of which having the ionic functional group.

Among these, a repeating unit derived from acrylic acid or methacrylic acid is preferable. That is, the copolymer preferably contains either one or both of a structural unit derived from acrylic acid and a structural unit derived from methacrylic acid.

The “repeating unit (or a structural unit) (of a polymer) derived from a (specific) monomer” herein means a unit that has a structure which can be typically incorporated into the polymer by employing the (specific) monomer as that to be polymerized for forming the polymer.

The repeating unit having an ionic group may be incorporated into the copolymer by forming a polymer chain of the copolymer by polymerizing monomers corresponding to the repeating unit. Alternatively, the repeating unit having an ionic group may be provided in the copolymer by introducing an ionic functional group into a polymer chain of the copolymer which has been formed by polymerization.

The content of the ionic group-containing repeating unit may be different depending on, for example, a ratio of the (a) repeating unit represented by Formula (1).

For example, when the copolymer is configured only of the (b) repeating unit having an ionic group (hydrophilic structural unit (A)) and the (a) repeating unit represented by Formula (1) (hydrophobic structural unit (B)), the content of the (b) repeating unit having an ionic group is obtained according to: [100—{(a) repeating unit represented by Formula (1)}(%)] in terms of percent by weight.

The (b) repeating unit having an ionic group may be used singly or in a combination of two or more thereof.

In preferable embodiments, the copolymer employed in the invention may contain the (b) repeating unit having an ionic group at a ratio of 15 weight % or less with respect to the total amount of the copolymer, and the (b) repeating unit having an ionic group may contain at least a structural unit derived from (meth)acrylic acid.

When the content of the (b) repeating unit having an ionic group is 15 weight % or less to the total amount of the polymer, the dispersion stability may tend to be more excellent.

The content of the (b) repeating unit having an ionic group may be preferably in the range of from 5 weight % to 15 weight %, and more preferably in the range of from 7 weight % to 13 weight %, with respect to a total amount of the copolymer from the viewpoint of dispersion stability of the copolymer.

The copolymer employed in the invention is preferably a resin made of a hydrophilic structural unit (A) and a hydrophobic structural unit (B) from the viewpoint of having the copolymer stably exist in an aqueous ink, alleviating adhering or deposition of aggregates and readily removing adhered aggregates. Herein, the hydrophobic structural unit (B) include the repeating unit represented by Formula (1).

Hydrophilic Structural Unit (A)

The copolymer that contains at least one kind of the (b) repeating unit having an ionic group may further have a hydrophilic structural unit having another hydrophilic functional group as long as an advantage of the invention is not impaired.

Examples of the other hydrophilic structural unit include a structural unit derived from a monomer having a nonionic hydrophilic group is cited. Specific examples thereof include vinyl monomers having a hydrophilic functional group such as (meth)acrylates having a hydrophilic functional group, (meth)acrylamides having a hydrophilic functional group, or vinyl esters having a hydrophilic functional group.

Examples of the “hydrophilic functional group” include a hydroxy group, an amino group, an amide group (having an unsubstituted nitrogen atom), and the alkylene oxides such as polyethylene oxide and polypropylene oxide described below.

The monomer for forming the hydrophilic structural unit containing a nonionic hydrophilic group is not particularly limited as long as it contains a functional group for forming a polymer, such as an ethylenically unsaturated bond, and a nonionic hydrophilic functional group. The monomer may be selected from known monomers. Specific examples of preferable monomers may include hydroxyethyl (meth)acrylate, hydroxybutyl (meth)acrylate, (meth)acrylamide, aminoethyl acrylate, aminopropyl acrylate, and (meth)acrylates containing an alkylene oxide polymer.

The hydrophilic structural unit (A) having a nonionic hydrophilic group may be incorporated into the copolymer by forming a polymer chain of the copolymer by polymerizing monomers corresponding to the hydrophilic structural unit. Alternatively, the hydrophilic structural unit having a nonionic hydrophilic group may be provided in the copolymer by introducing a hydrophilic functional group into a polymer chain of the copolymer which has been formed by polymerization.

The hydrophilic structural unit having a nonionic hydrophilic group is more preferably a hydrophilic structural unit having an alkylene oxide structure. From the viewpoint of hydrophilicity, the alkylene moiety of the alkylene oxide structure preferably has 1 to 6 carbon atoms, more preferably has 2 to 6 carbon atoms, and still more preferably has 2 to 4 carbon atoms. The degree of polymerization of the alkylene oxide structure is preferably 1 to 120, more preferably 1 to 60, and still more preferably 1 to 30.

In one preferable embodiment, the hydrophilic structural unit having a nonionic hydrophilic group is a hydroxyl group-containing hydrophilic functional unit. The number of a hydroxyl group in the structural unit, although being not particularly limited, is preferably 1 to 4, more preferably 1 to 3, and still more preferably 1 to 2, from the viewpoint of the hydrophilicity of the copolymer and compatibility with a solvent and other monomers at the time of polymerization.

In preferable embodiments, the copolymer employed in the invention may contain the hydrophilic structural unit (A) at a ratio of 15 weight % or less with respect to the total amount of the copolymer.

The content ratio of the hydrophilic structural unit may vary depending on the content ratio of the hydrophobic structural unit (B) and/or the like. For example, when the copolymer is composed exclusively of acrylic acid and/or methacrylic acid (hydrophilic structural unit (a)) and the hydrophobic structural unit (B), the content ratio of acrylic acid and/or methacrylic acid may be determined by “100—(the hydrophobic structural unit) (mass %)”.

The hydrophilic structural unit (A) may be used singly or as a mixture of two or more thereof.

Hydrophobic Structural Unit (B)

In addition to the repeating unit represented by Formula (1), the hydrophobic structural unit (B) in the copolymer employed in the invention may further contain another hydrophobic structural unit as long as the effect of the invention is not impaired.

Examples of the hydrophobic structural unit (B) other than the repeating unit represented by Formula (1) include structural units which do not belong to the hydrophilic structural unit (for example, those containing no hydrophilic functional group) such as structural units derived from (meth)acrylates, (meth)acrylamides, styrenes, and vinyl monomers such as vinyl esters, and a hydrophobic structural unit containing an aromatic ring linked to an atom in the main chain via a linking group. These structural units may be used alone or in combination of two or more thereof.

Examples of the (meth)acrylates include methyl (meth)acrylate, ethyl (meth)acrylate, butyl (meth)acrylate, isobutyl (meth)acrylate, and hexyl (meth)acrylate. Among them, methyl (meth)acrylate, ethyl (meth)acrylate, and butyl (meth)acrylate are preferable, and methyl (meth)acrylate and ethyl (meth)acrylate are particularly preferable.

Examples of the (meth)acrylamides include N-cyclohexyl (meth)acrylamide, N-(2-methoxy ethyl)(meth)acrylamide, N,N-diallyl (meth)acrylamide, and N-allyl (meth)acrylamide.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, chloromethylstyrene, hydroxystyrene protected with a group removable with an acidic substance (for example, t-Boc), methyl vinyl benzoate, α-methylstyrene, and vinylnaphthalene. Among them, styrene and α-methylstyrene are preferable.

Examples of the vinyl esters include vinyl acetate, vinyl chloroacetate, vinyl propionate, vinyl butylate, vinyl methoxy acetate, and vinyl benzoate. Among them, vinyl acetate is preferable.

The “hydrophobic structural unit containing an aromatic ring linked to an atom in the main chain via a linking group” is preferably a structural unit wherein the proportion of the aromatic ring linked to an atom in the main chain of the copolymer via a linking group is from 15 weight % to 27 weight %, more preferably from 15 to 25 weight %, and even more preferably from 15 weight % to 20 weight % with respect to the copolymer.

The aromatic ring is linked to the atom in the main chain of the copolymer not directly but via a linking group. Therefore, an adequate distance is kept between the hydrophobic aromatic ring and the hydrophilic structural unit, so that the copolymer readily interacts with the pigment and is firmly adsorbed thereon, thus improving the dispersibility of the pigment.

The “hydrophobic structural unit containing an aromatic ring linked to an atom in the main chain via a linking group” is preferably a structural unit represented by the following Formula (2) (excluding the repeating unit represented by Formula (1)):

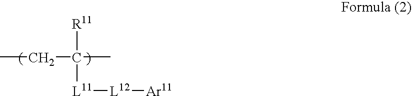

In Formula (2), R¹¹ represents a hydrogen atom, a methyl group, or a halogen atom. L¹¹ represents *—COO—, *—OCO—, *—CONR²—, *—O—, or a substituted or unsubstituted phenylene group, and R¹² represents a hydrogen atom or an alkyl group having 1 to 10 carbon atoms. In the group represented by L¹¹, an asterisk (*) denotes a position of a bond connected to the main chain.

L¹² represents a single bond or a divalent linking group having 1 to 30 carbon atoms. When L¹² is a divalent linking group, it is preferably a linking group having 1 to 25 carbon atoms, more preferably a linking group having 1 to 20 carbon atoms, and more preferably a linking group having 1 to 15 carbon atoms.

Among them, particularly preferable examples include an alkyleneoxy group having 1 to 25 (more preferably 1 to 10) carbon atoms, an imino group (—NH—), a sulfamoyl group, and divalent linking groups containing an alkylene group, such as an alkylene group having 1 to 20 carbon atoms (more preferably 1 to 15) or an ethylene oxide group [—(CH₂CH₂O)ₙ—, n=1 to 6], and combinations of two or more of these groups.

In Formula (2), Ar¹¹ represents a monovalent group derived from an aromatic ring.

The aromatic ring represented by Ar¹¹ is not particularly limited, and examples thereof include a benzene ring, a condensed aromatic ring having eight or more carbon atoms, an hetero ring containing condensed aromatic rings, and two or more benzene rings linked to each other. The details about the condensed aromatic ring having eight or more carbon atoms and the hetero ring containing condensed aromatic rings have been described above.

Specific examples of the monomer for forming the hydrophobic structural unit (B) other than the repeating unit represented by Formula (1) are shown below. However, the invention is not limited to the following specific examples.

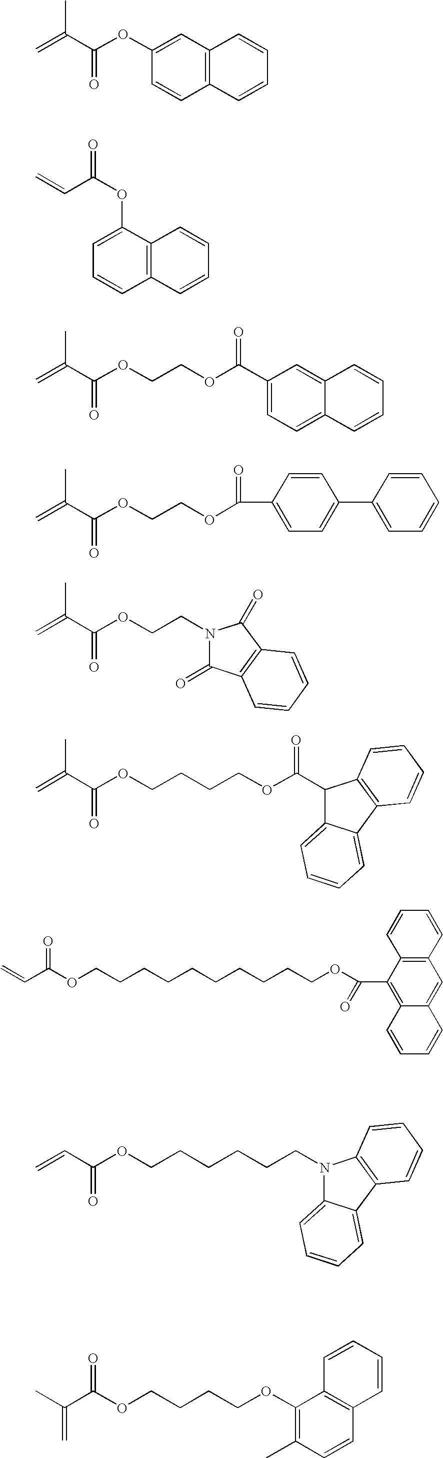

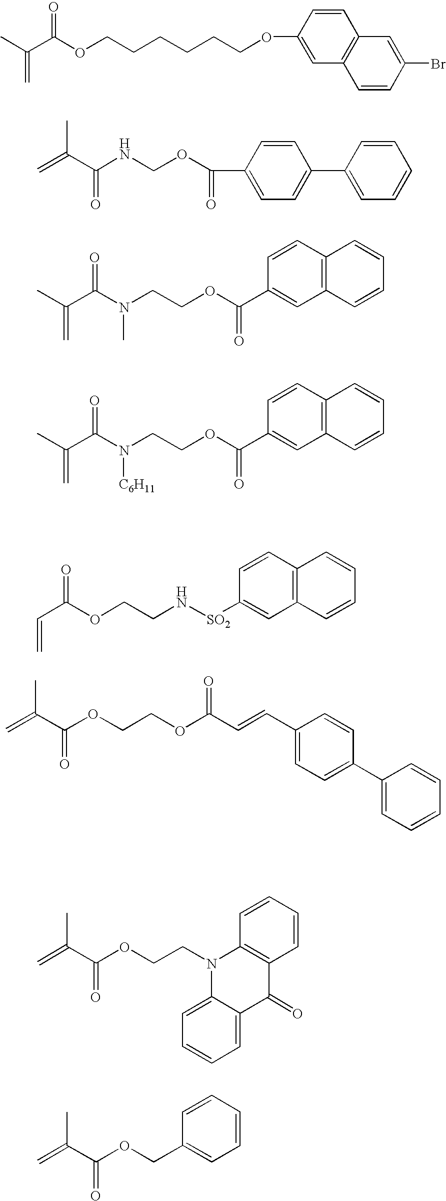

In the copolymer employed in the invention, the ratio of the hydrophilic structural unit (A) to the hydrophobic structural unit (B) (including the repeating unit represented by Formula (1)) may depend on the degrees of the hydrophilicity and hydrophobicity of these components. Typically, the content of the hydrophilic structural unit (A) in the copolymer is preferably 15 weight % or less. The content of the hydrophobic structural unit (B) is preferably more than 80 weight %, and more preferably 85 weight % or more with respect to the total amount of the copolymer.

If the content of the hydrophilic structural unit (A) is 15 weight % or less, the amount of the component which singly dissolved in the aqueous medium may be decreased, which results in the improvement of pigment properties such as dispersibility, whereby good ink ejection properties may be achieved during inkjet recording.

The content ratio of the hydrophilic structural unit (A) is preferably more than 0 weight % but 15 weight % or less, more preferably from 2 weight % to 15 weight %, even more preferably from 5 weight % to 15 weight %, and particularly preferably from 8 weight % to 12 weight % with respect to the total amount of the copolymer.

In the invention, the acid value of the copolymer is preferably in the range of from 30 mgKOH/g to 100 mgKOH/g, more preferably in the range of from 30 mgKOH/g to 85 mgKOH/g, and particularly preferably in the range of from 50 mgKOH/g to 85 mgKOH/g from the viewpoints of pigment dispersibility and storage stability.

Specifically, when the acid value of the copolymer is 30 mgKOH/g or more, storage stability may tend to be improved. When the acid value of the copolymer is 100 mgKOH/g or less, pigment dispersibility may tend to be improved.

The acid value is defined as the mass (mg) of KOH necessary for completely neutralizing 1 g of the copolymer, and measured by the method described in Japanese Industrial Standard (JIS K0070, 1992), the disclosure of which is incorporated by reference herein.

The weight average molecular weight (Mw) of the copolymer employed in the invention is preferably 30000 or more, more preferably from 30000 to 150000, even more preferably from 30000 to 100000, particularly preferably from 30000 to 80000, and most preferably from 30000 to 60000. If the molecular weight is 30000 or more, the copolymer may provide a good steric repulsion effect as a dispersant, and is readily adsorbed on the pigment owing to the steric effect.

The number average molecular weight (Mn) of the copolymer is preferably about 1,000 to 100,000, and particularly preferably about 3,000 to 50,000. When the number average molecular weight is within the range, the copolymer may serve as a coating on the pigment or a coating of the ink composition. The copolymer employed in the invention is preferably used in the form of an alkali metal salt or an organic amine salt.

The molecular weight distribution of the copolymer employed in the invention (weight average molecular weight/number average molecular weight) is preferably from 1 to 6, and more preferably from 1 to 4. When the molecular weight distribution is within the above-described range, the resultant ink may have improved dispersion stability and jetting stability.

The number average molecular weight and the weight average molecular weight are measured by the differential refractometer detection with THF as a solvent in a GPC analyzer using columns TSKgel GMHxL, TSKgel G4000 HxL and TSKgel G2000 HxL (manufactured by Tosoh Corporation), and is obtained by conversion with a polystyrene reference material.

The copolymer employed in the invention may be synthesized by any polymerization method such as solution polymerization, precipitation polymerization, suspension polymerization, bulk polymerization, or emulsion polymerization. The polymerization reaction may be carried out under a known system, such as a batch, semi-continuous, or continuous system. Initiation of the polymerization may be carried out with a radical initiator, or photoirradiation or radiation-irradiation. These methods of polymerization and initiation of polymerization are described in, for example, “Kobunshi Gosei Hoho” by Teiji Turuta, Revised Edition (published by Nikkan Kogyo Shimbun, Ltd., 1971) and “Kobunshi Gosei no Jikkenho” by Takayuki Ohtu and Masaetu Kinoshita (published by Kagaku-Dojin Publishing Company Inc., 1972) pp. 124 to 154.

Among these polymerization methods, a solution polymerization method using a radical initiator is preferable. Examples of the solvent used in the solution polymerization method include various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. These solvents may be used alone or in combination of two or more thereof, or may be mixed with water as a mixed solution. The polymerization temperature should be chosen in consideration of the molecular weight of the intended polymer and the type of the initiator, and is usually from 0° C. to 100° C., and is preferably from 50° C. to 100° C. The reaction pressure may be appropriately selected, and is usually from 1 kg/cm² to 100 kg/cm², and particularly preferably about from 1 kg/cm² to 30 kg/cm². The reaction period may be about 5 hours to 30 hours. The resultant resin may be subjected to purification treatment such as reprecipitation.

Specific examples of preferable copolymers of the invention are shown below with weight ratio of structural units, weight-average molecular weight and acid value. The invention is not limited to these examples.
Copolymer of [(Mixture of M-25 and M-27)/ethyl methacrylate/methacrylic acid (weight ratio:15/75/10, Mw: 49400, acid value: 65.2)
Copolymer of M-25/ethyl methacrylate/methacrylic acid (weight ratio:18/69/13, Mw: 41600, acid value: 84.7)
Copolymer of [(Mixture of M-28/M-29)/ethyl methacrylate/methacrylic acid (weight ratio:15/85/10, Mw: 38600, acid value: 65.2)
Copolymer of M-28/ethyl methacrylate/methacrylic acid (weight ratio:20/73/7, Mw: 45300, acid value: 45.6)

Pigment

The pigment to be coated with the copolymer employed in the invention is described below.

The pigment is not particularly limited, and may be appropriately selected according to the intended use. The pigment may be, for example, an organic or inorganic pigment.

Examples of the organic pigment include azo pigments, polycyclic pigments, dye chelates, nitro pigments, nitroso pigments, and aniline black. Among them, azo pigments and polycyclic pigments are more preferable.

Examples of the azo pigments include azo lakes, insoluble azo pigments, condensed azo pigments, and chelate azo pigments.

Examples of the polycyclic pigment include phthalocyanine pigments, perylene pigments, perinone pigments, anthraquinone pigments, quinacridone pigments, dioxazine pigments, indigo pigments, thio indigo pigments, isoindolinone pigments, and quinophthalone pigments.

Examples of the dye chelates include basic dye chelates and acidic dye chelates.

Organic pigments usable in the invention include yellow ink pigments such as C. I. Pigment Yellow 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155 or 180.

Organic pigments usable in the invention further include magenta ink pigments such as C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (iron oxide red), 104, 105, 106, 108 (cadmium red), 112, 114, 122 (quinacridone magenta), 123, 146, 149, 163, 166, 168, 170, 172, 177, 178, 179, 184, 185, 190, 193, 202, 209, 219, 269 or C.I. pigment violet 19. Among these pigments, C.I. pigment red 122 is particularly preferable.

Organic pigments usable in the invention further include cyan ink pigments such as C.I. Pigment Blue 1, 2, 3, 15, 15:1, 15:2, 15:3, 15:34, 16, 17:1, 22, 25, 56, 60, C.I. Bat Blue 4, 60 or 63. Among these pigments, C. I. Pigment Blue 15:3 is particularly preferable.

Examples of the inorganic pigments include titanium oxide, iron oxide, calcium carbonate, barium sulfate, aluminum hydroxide, barium yellow, cadmium red, chrome yellow, and carbon black. Among these pigments, carbon black is particularly preferable. The carbon black may be, for example, a carbon black manufactured by a known method such as a contact method, a furnace method or a thermal method.

Specific examples of a carbon black, which is a black pigment, include RAVEN 7000, RAVEN 5750, RAVEN 5250, RAVEN 5000 ULTRAII, RAVEN 3500, RAVEN 2000, RAVEN 1500, RAVEN 1250, RAVEN 1200, RAVEN 1190 ULTRAII, RAVEN 1170, RAVEN 1255, RAVEN 1080, RAVEN 1060 and RAVEN700 (trade names, manufactured by Columbian Chemicals Co.); REGAL 400R, REGAL 330R, REGAL 660R, MOGUL L, BLACK PEARLS L, MONARCH 700, MONARCH 800, MONARCH 880, MONARCH 900, MONARCH 1000, MONARCH 1100, MONARCH 1300 and MONARCH 1400 (trade names, manufactured by Cabot Corporation); COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A and SPECIAL BLACK 4 (trade names, manufactured by Degussa); and No. 25, No. 33, No. 40, No. 45, No. 47, No. 52, No. 900, No. 2200B, No. 2300, MCF-88, MA600, MA7, MA8 and MA100 (trade names, manufactured by Mitsubishi Chemical Corporation), although the black pigment employable in the invention is not limited thereto.

The pigment may be used singly or in combination of two or more thereof, each of which may be selected from the above classes of pigments and may belong to the same class as each other or different classes from each other.

The weight ratio (p:r) between the pigment (p) and the copolymer (r) in the invention is preferably from 100:25 to 100:140, and more preferably from 100:25 to 100:50. When the ratio of the copolymer is 25 or more, dispersion stability and abrasion resistance may tend to improve, and when 140 or less, dispersion stability may tend to improve.

A particle diameter (volume-average particle diameter) in a dispersion of the resin-coated pigment particle in the invention is preferably in the range of 50 nm to 120 nm, more preferably in the range of 60 nm to 100 nm, and still more preferably in the range of 70 nm to 90 nm.

When the particle diameter is 50 nm or more, deterioration of stability may tend to be inhibited. When the particle diameter is 120 nm or less, jetting performance may become excellent and formation of white spot in a recorded image preferably may tend to be inhibited.

The particle size distribution of the resin-coated pigment particle is not particularly restricted. The particle size distribution may be either a broad particle size distribution or a mono-disperse particle size distribution. In embodiments, two kinds of dispersion having a mono-disperse particle size distribution may be used in combination.

A volume average particle diameter measured by a dynamic light-scattering method with a particle size distribution analyzer NANOTRACK UPA-EX150 (trade name, manufactured by Nikkiso Co., Ltd.) is adopted as the particle diameter of the resin-coated pigment particle.

The resin-coated pigment (microcapsulated pigment) in the invention may be produced from the copolymer, the pigment and the like by a known physical or chemical method such as that described in JP-A Nos. 9-151342, 10-140065, 11-209672, 11-172180, 10-25440, and 11-43636. Specific examples of the method include the phase inversion method and acid precipitation method described in JP-A Nos. 9-151342 and 10-140065. Of these methods, the phase inversion emulsification method is preferable from the viewpoint of dispersion stability.

Details of the phase-inversion emulsification method and the acid precipitation method are explained below.

### a) Phase-Inversion Emulsification Method

The phase-inversion method is a self-dispersing method, which may basically include dispersing a mixture of a pigment and a water-soluble or self-dispersing resin in water, in which the “mixture” refers to a state in which the components in an undissolved state are mixed, or a state in which the components are dissolved and mixed, or a state including both of the above states, and may contain the curing agent or the polymer compound. Specific examples of the phase-inversion method include that described in JP-A No. 10-140065.

### b) Acid Precipitation Method

The acid precipitation method is a method which includes preparing a water-containing cake containing a resin and a pigment, and neutralizing a part or all of anionic groups of the resin in the water-containing cake with a basic compound to produce an encapsulated pigment.

Specifically, the acid precipitation method includes (1) dispersing a resin and a pigment in an alkaline aqueous medium, and may further heat-treating the resultant if necessary, to produce a gel of the resin, (2) neutralizing or acidifying the system to hydrophobize the resin so as to firmly adhere the resin to a pigment, (3) performing filtration and water washing as necessary to yield a water-containing cake, (4) neutralizing, with a basic compound, a part or the all of anionic groups of the resin in the water-containing cake, and then re-dispersing the resin in an aqueous medium, and (5) performing heating as necessary to produce a gel of the resin.

More specific methods of the phase-inversion emulsification and the acid precipitation method are shown in JP-A Nos. 9-151342 and 10-14006.

In an aqueous ink composition in embodiments of the invention, the resin-coated pigment employed in the invention may be prepared using a copolymer having the repeating unit represented by Formula (1) and the (b) repeating unit having an ionic group through the preparation method for preparing a dispersion of the resin-coated pigment including the following processes (1) and (2). The aqueous ink composition of the invention may be prepared by this preparation method followed by employing the obtained dispersion of the resin-coated pigment, water, and an organic solvent to prepare the aqueous ink composition.

Process (1): Stirring a mixture containing a copolymer having the repeating unit represented by Formula (1) and the (b) repeating unit having an ionic group, an organic solvent, a neutralizer, and an aqueous medium; and

Process (2): Removing the organic solvent from the mixture.

There is no limitation on a stirring method of the mixture, and generally-used mixing and stirring devices or, as required, dispersers such as an ultrasonic disperser or a high voltage homogenizer can be used.

Preferable examples of the organic solvent include an alcohol solvent, a ketone solvent, and an ether solvent.

Examples of the alcohol solvent include isopropyl alcohol, n-butanol, t-butanol, and ethanol. Examples of the ketone solvent include acetone, methyl ethyl ketone, diethyl ketone, and methyl isobutyl ketone. Examples of the ether solvent include dibutyl ether and dioxane. Among the solvents, the ketone solvent, such as methyl ethyl ketone, and the alcohol solvent, such as isopropyl alcohol, are preferable, and methyl ethyl ketone is more preferable.

The neutralizer is used for forming an emulsion state or a dispersion state in which the dissociative group is partially or thoroughly neutralized and the specific copolymer is stabilized in water. Details of the neutralizer is described below.

In the process (2), a dispersion of the resin-coated pigment particles can be obtained by inverting a phase of the dispersion, which has been obtained in the process (1), to a water phase by common procedures such as vacuum distillation distilling off the organic solvent therefrom. The thus-obtained dispersion is substantially free of the organic solvent. The amount of the organic solvent contained in the dispersion is preferably 0.2 mass % or less, and more preferably 0.1 mass % or less.

More specifically, the method for forming the resin-coated pigment includes, for example: (1) mixing an anionic group-containing copolymer or its solution in an organic solvent with a base compound (neutralizer) thereby carrying out neutralization; (2) mixing the obtained mixed solution with a pigment to make a suspension, and then dispersing the pigment with a disperser to obtain a pigment dispersion; and (3) removing the organic solvent by, for example, distillation thereby coating the pigment with the anionic group-containing specific copolymer, and dispersing the coated pigment particles in an aqueous medium to make an aqueous dispersion.

This method is further detailed in JP-A Nos. 11-209672 and 11-172180.

In the invention, the dispersing treatment may be carried out using, for example, a ball mill, a roll mill, a bead mill, a high-pressure homogenizer, a high-speed stirring disperser, or an ultrasonic homogenizer.

The content of the pigment coated with copolymer employed in the invention is preferably from 1 weight % to 10 weight %, more preferably from 2 weight % to 8 weight %, and particularly preferably from 2 weight % to 6 weight %, from the viewpoints of the dispersion stability and concentration of the aqueous ink composition.

Water

The ink composition employed in the invention contains water.

While the amount of water contained in the ink composition is not particularly limited, the addition amount of water is preferably from 10 mass % to 99 mass %, more preferably from 30 mass % to 80 mass %, and still more preferably from 50 mass % to 70 mass %, with respect to the total amount of the ink composition.

Neutralizer

The ink composition of the invention contains at least one neutralizer. The neutralizer is used for neutralizing acid groups contained in the copolymer during preparation of the pigment particles coated with the copolymer. The amount of the neutralizer is preferably from 0.5 to 1.5 equivalents, and more preferably from 1 to 1.5 equivalents with respect to the acid value of the copolymer.

Examples of the neutralizer include alcohol amines (for example, diethanolamine, triethanolamine, 2-amino-2-ethyl-1,3-propanediol), alkali metal hydroxides (for example, lithium hydroxide, sodium hydroxide, potassium hydroxide), ammonium hydroxide (for example, ammonium hydroxide, quaternary ammonium hydroxide), phosphonium hydroxides, and alkali metal carbonates. Among them, sodium hydroxide and potassium hydroxide are preferably used.

Surfactant

The ink composition of the invention preferably contains at least one surfactant. The surfactant is used as a surface tension regulator. Examples of the surfactant include nonionic, cationic, anionic, and betaine surfactants.

In order to achieve good ink ejection, the surfactant is preferably used in an amount such that the aqueous ink composition has a surface tension of from 20 mN/m to 60 mN/m. Further, the surfactant is preferably used in an amount such that the surface tension is from 20 mN/m to 45 mN/m, and more preferably the surface tension is from 25 mN/m to 40 mN/m.

Examples of effective surfactants may include compounds containing hydrophilic and hydrophobic moieties within one molecule thereof. The surfactant may also be anionic, cationic, ampholytic, or nonionic.

Specific examples of the anionic surfactants include sodium dodecylbenzene sulfonate, sodium lauryl sulfate, sodium alkyl diphenyl ether disulfonate, sodium alkyl naphthalene sulfonate, sodium dialkyl sulfosuccinate, sodium stearate, potassium oleate, sodium dioctyl sulfosuccinate, sodium polyoxyethylene alkyl ether sulfate, sodium polyoxyethylene alkyl phenyl ether sulfate, sodium dialkyl sulfosuccinate, sodium stearate, sodium oleate, and sodium t-octylphenoxy ethoxypolyethoxyethyl sulfate. These anionic surfactancs may be used alone or in combination of two or more thereof.

Examples of the nonionic surfactants include poly(oxyethylene)alkyl ethers, poly(oxyethylene) phenyl ethers, and acetyleneglycol surfactants.

Specific examples of the poly(oxyethylene)alkyl ethers and the poly(oxyethylene) phenyl ethers include poly(oxyethylene)lauryl ether, poly(oxyethylene)octylphenyl ether, poly(oxyethylene)oleylphenyl ether, and poly(oxyethylene)nonylphenyl ether. These nonionic surfactants may be used alone or in combination of two or more thereof.

Specific examples of the acetyleneglycol surfactants include 2,4,7,9-tetramethyl-5-decyne-4,7-diol, 3,6-dimethyl-4-Octyne-3,6-diol, 3,5-dimethyl-1-hexyne-3-ol, and a substance obtained by adding, to each of plural hydroxyl groups in any one of these compounds, an ethyleneoxy group or a propyleneoxi group so that an average number of the added ethyleneoxy group(s) or the added propyleneoxi group(s) to each molecule of the substance is 1 to 30. Commarcially-available acetyleneglycol surfactants may be also employed, and examples thereof include “OLFINE E 1010” and “OLFINE STG” (both trade names, manufactured by Nisshin Chemical Industry Co., Ltd.). These acetyleneglycol surfactants may be used alone or in combination of two or more thereof.

Examples of the cationic surfactants include tetraalkyl ammonium salts, alkylamine salts, benzalkonium salts, alkylpyridium salts, and imidazolium salts, and specific examples thereof include dihydroxyethylstearylamine, 2-heptadecenyl-hydroxyethylimidazoline, lauryldimethylbenzylammonium chloride, cetylpyridinium chloride, and stearamidomethylpyridinium chloride.

The content of the surfactant in the aqueous ink composition is not particularly limited, and is preferably 1 weight % or more, more preferably 1 weight % to 10 weight %, and even more preferably 1 weight % to 3 weight %.

Other Components

In addition to the above-described components, the ink composition of the invention may further contain other components such as resin fine particles or a polymer latex. Examples of the other components which can be included if necessary further include an ultraviolet absorber, an anti-fading agent, a fungicide, a rust preventive agent, an antioxidant, an emulsification stabilizer, a preservative, an anti-foaming agent, a viscosity regulator, a dispersion stabilizer, and a chelating agent.

Examples of the resin fine particles include fine particles of acrylic resins, vinyl acetate resins, styrene-butadiene resins, vinyl chloride resins, acryl-styrene resins, butadiene resins, styrenic resins, crosslinked acrylic resins, crosslinked styrenic resins, benzoguanamine resins, phenolic resins, silicone resins, epoxy resins, urethane resins, paraffin resins, or fluorine resins. These resins may be used in the form of polymer latexes containing these resins.

Among the above resins, acrylic resins, acryl-styrene resins, styrenic resins, crosslinked acrylic resins, and crosslinked styrenic resins are preferable.

The weight average molecular weight of the resin fine particles is preferably 10000 or more but 200000 or less, and more preferably 100000 or more but 200000 or less.

The average particle diameter of the resin fine particle is preferably from 10 nm to 1 μm, more preferably from 10 nm to 200 nm, even more preferably from 20 nm to 100 nm, and particularly preferably from 20 nm to 50 nm.

The addition amount of the resin fine particles is preferably from 0.5 weight % to 20 weight %, more preferably from 3 weight % to 20 weight %, and even more preferably from 5 weight % to 15 weight % with respect to the total amount of the ink.

The glass transition temperature (Tg) of the resin fine particles is preferably 30° C. or higher, more preferably 40° C. or higher, and even more preferably 50° C. or higher.

The polymer particles are not particularly limited as to their particle diameter distribution, and may have a broad particle diameter distribution or a monodispersed particle diameter distribution. In embodiments, a mixture of two or more kinds of polymer fine particles each having a monodispersed particle diameter distribution may be used.

Examples of the ultraviolet absorber include benzophenone ultraviolet absorbers, benzotriazole ultraviolet absorbers, salicylate ultraviolet absorbers, cyanoacrylate ultraviolet absorbers, and nickel complex salt ultraviolet absorbers.

The anti-fading agent may be selected from various organic and metal complex anti-fading agents. Examples of the organic anti-fading agents include hydroquinones, alkoxy phenols, dialkoxy phenols, phenols, anilines, amines, indans, chromanes, alkoxy anilines, and heterocycles. Examples of the metal complexes include nickel complexes and zinc complexes.

Examples of the fungicide include sodium dehydroacetate, sodium benzoate, sodium pyridinethione-1-oxide, p-hydroxybenzoic acid ethyl ester, 1,2-benzisothiazoline-3-one, sodium sorbate, and sodium pentachlorophenolate. The content of the fungicide in an ink is preferably from 0.02 to 1.00 weight %.

Examples of the rust preventive agent include acidic sulfites, sodium thiosulfate, ammonium thioglycolate, diisopropyl-ammonium nitrite, pentaerythritol tetranitrate, and dicyclohexylammonium nitrite.

Examples of the antioxidant include phenol antioxidants (including hindered phenol antioxidants), amine antioxidants, sulfur containing antioxidants, and phosphorus containing antioxidants.

Examples of the chelating agent include sodium ethylenediamine tetraacetate, sodium nitrilotriacetate, sodium hydroxyethyl-ethylnediamine triacetate, sodium diethylenetriamine pentaacetate, and sodium uramildiacetate.

Physical Properties of Aqueous Ink Composition

The surface tension (25° C.) of the aqueous ink composition of the invention is preferably 20 mN/m or more but 60 mN/m or less, more preferably 20 mN/m or more but 45 mN/m or less, and even more preferably 25 mN/m or more but 40 mN/m or less.

The surface tension may be measured with an aqueous ink at 25° C. using Automatic Surface Tensiometer CBVP-Z (manufactured by Kyowa Interface Science Co., Ltd.).

The aqueous ink composition of the invention preferably has a viscosity (at 20° C.) of 1.2 mPa·s or more but 15.0 mPa·s or less, more preferably 2 mPa·s or more but less than 13 mPa·s, and even more preferably 2.5 mPa·s or more but less than 10 mPa·s.

The viscosity may be measured with an aqueous ink at 20° C. using VISCOMETER TV-22 (manufactured by Toki Sangyo Co., Ltd.).

The aqueous ink composition of the invention may be used for the formation of a multi-color image (for example, a full color image). For the formation of a full color image, ink compositions having magenta, cyan, and yellow colors may be used, and additionally an ink composition having a black color may also be used to adjust the color tone.

In addition to the yellow (Y), magenta (M), and cyan (C) color ink compositions, other ink compositions such as those having red (R), green (G), blue (B), and white (W) colors, or those having so-called special colors used in the printing field may be used.

The ink compositions having intended colors are prepared by changing as desired the color pigment used as the coloring agent.

The ink composition of the invention may be employed in an ink set for ink jet recording by being combined with an aqueous liquid composition described below.

Aqueous Liquid Composition

The aqueous liquid composition in the inkjet recording ink set of the invention contains at least one aggregation component for aggregating the pigment in the aqueous ink composition when the aqueous liquid composition is mixed with the aqueous ink composition, and optionally may further contain other components.

Aggregation Component

The aqueous liquid composition contains at least one aggregation component for aggregating the pigment in the aqueous ink composition. The aqueous liquid composition is mixed with the aqueous ink composition ejected by an inkjet method, thereby promoting the aggregation of the pigment stably dispersed in the aqueous ink composition.

Examples of the aqueous liquid composition include a liquid composition which may form aggregate by changing the pH of the aqueous ink composition. In this case, the pH of the aqueous liquid composition (25° C.) is preferably 6 or less, and more preferably 4 or less. In particular, the pH (25° C.) is preferably from 1 to 4, and particularly preferably from 1 to 3. In this case, the pH of the aqueous ink composition (25° C.) is preferably 7.5 or more, and more preferably 8 or more.

In the invention, from the viewpoints of image density, resolution, and speedup of inkjet recording, it is particularly preferable that the pH of the aqueous ink composition (25° C.) be 7.5 or more, and the pH of the aqueous liquid composition (25° C.) be 4 or less.

Examples of the aggregation component for aggregating the pigment include multivalent metal salts, organic acids, polyallylamines, and modified compounds thereof.

Examples of the multivalent metal salts may include salts of alkaline earth metals of group 2 in the periodic table (for example, magnesium and calcium), transition metals of group 3 in the periodic table (for example, lanthanum), cations of group 13 in the periodic table (for example, aluminum), and lanthanides (for example, neodymium). Among these metal salts, carboxylates (for example, formates, acetates, and benzoates), nitrates, chlorides, and thiocyanates are preferable. Among them, calcium salts or magnesium salts of carboxylates (for example, formates, acetates, and benzoates), calcium salts or magnesium salts of nitrates, calcium chloride, magnesium chloride, and calcium salts or magnesium salts of thiocyanates are particularly preferable.

The organic acid may be appropriately selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrolecarboxylic acid, furancarboxylic acid, pyridinecarboxylic acid, coumaric acid, thiophenecarboxylic acid, nicotinic acid, modified compounds of these compounds, and salts of these compounds.

The aggregation component may be used alone or in combination of two or more thereof.

The content of the aggregation component for aggregating the pigment is preferably from 1 weight % to 20 weight %, more preferably from 5 weight % to 20 weight %, and even more preferably from 10 weight % to 20 weight %, with respect to the total amount of the aqueous liquid composition.

Image Recording Method

Image recording can be performed by using the ink composition of the invention.

The method for the image recording includes: applying the aqueous ink composition of the invention, which contains a copolymer (copolymer including the (a) repeating unit represented by Formula (1) and the (b) repeating unit having an ionic group), a pigment, an organic solvent, a neutralizer, and water, onto a recording medium by an inkjet method; and applying an aqueous liquid composition, which contains a component for aggregating the pigment in the aqueous ink composition, onto the recording medium, so that the aqueous ink composition is brought into contact with the aqueous liquid composition so as to form an image.

In the image recording method of the invention, the aqueous ink composition containing the pigment coated with the copolymer is used as a colorant when an image is recorded through the aggregation caused by the contact between the aqueous ink composition and aqueous liquid composition at the time of recording. Therefore, the adhesion or deposition of aggregate on the liquid ejection portion formed by the contact between the two liquids may be impeded, and the removal of the aggregate attached thereto may be facilitated. As a result, directional failure of ink ejection may be suppressed, and the occurrence of image defects such as white spots may be suppressed, whereby high resolution image may be recorded. The decrease of the maintenance frequency of the jetting apparatus and improvement of the maintainability of the apparatus may also be achieved.

In the applying of the ink, the aqueous ink composition is applied by an inkjet method. More specifically, the applying of the ink include imparting energy to the aqueous ink composition to eject the ink to form an image on a desired image receiving material such as plain paper, resin coated paper, inkjet paper such as those described in JP-A-Nos. 8-169172, 8-27693, 2-276670, 7-276789, 9-323475, 62-238783, 10-153989, 10-217473, 10-235995, 10-217597 or 10-337947, a film, electrophotographic common paper, fabrics, glass, metal or ceramics. In embodiments, the inkjet recording method described in the paragraphs 0093 to 0105 of JP-A No. 2003-306623 can be employed as a preferable inkjet recording method.

There is no particular limitation on the ink jet method in the invention. Any known method, such as an electrical charge control method in which an ink is jetted utilizing electrostatic attraction force, a drop-on-demand method (pressure pulse method) utilizing vibration pressure of a piezo-electric element, an acoustic ink jet method including changing an electrical signal into an acoustic beam, irradiating an ink with the acoustic beam, and jetting the ink utilizing radiation pressure, or a thermal ink jet (BUBBLE JET®) method including heating an ink to form bubbles and utilizing pressure generated therefrom, may be employed. Specifically, in embodiments, an ink jet method including jetting an ink from a nozzle by working force caused by a state change, which is a drastic change in volume of the ink occurring when thermal energy action is applied thereto, as described in JP-A 54-59936, can be effectively used.

The scope of the ink jet method includes: a method including jetting a large number of small volume-droplets of ink with low concentration, referred to as a photo ink; a method including using a plurality of inks that have substantially same hue and different concentration in view of improving image quality; a method including using a colorless transparent ink; and the like.

An ink jet head used in the ink jet method may be an on-demand type or a continuous type. Specific examples of a jetting system employed in the ink jet method include an electricity-machine conversion (such as a single cavity type, a double cavity type, a bender type, a piston type, a share mode type, or a shared wall type), an electricity-heat conversion (such as a thermal ink jet type or a BUBBLE JET® type), an electrostatic suction (such as an electric field control type or a slit jet type), and an electric jetting (such as a spark jet type), and any jetting method may be used.

An ink nozzle or the like to be used when recording is performed by the ink jet method is not particularly limited, and can be suitably selected according to the purpose.

In the applying of the aggregation component, the aqueous liquid composition is applied onto the recording medium before or after the application of the aqueous ink composition. The application of the aqueous liquid composition may be performed by a known method such as a coating method, an inkjet method, or a dipping method. The application method may use a known means such as a bar coater, an extrusion die coater, an air doctor coater, a blade coater, a rod coater, a knife coater, a squeeze coater, a reverse roll coater, or a bar coater. The details about the inkjet method are the same as described above.

In the invention, the applying of the aggregation component, in which the aqueous liquid composition is applied, may be followed by the applying of the ink. More specifically, in embodiments the aqueous liquid composition for aggregating the pigment in the aqueous ink composition may be applied onto the recording medium before the application of the aqueous ink composition so as to bring the aqueous ink composition into contact with the aqueous liquid composition applied on the recording medium so as to form an image. In such embodiments, inkjet recording may be performed at higher speed, and an image having a high density and high resolution may be produced even when high-speed recording is performed.

In the formation of an image, a polymer latex compound may also be used to impart glossiness and water resistance to the image, and to improve weather resistance of the image. The latex compound may be applied before, after, or at the same time of the application of the aqueous ink composition. The latex compound may be imparted in a recording medium, may be contained in the aqueous ink composition, or may be prepared in an independent liquid for application.

Specific examples thereof include those described in JP-A Nos. 2002-166638 (Application No. 2000-363090), 2002-121440 (Application No. 2000-315231), 2002-154201 (Application No. 2000-354380), 2002-144696 (Application No. 2000-343944), and 2002-080759 (Application No. 2000-268952).

In addition to the applying an aqueous ink composition and the applying an aqueous liquid composition to apply aggregation component, the image formation method may further include other processes. The other processes are not particularly limited, and may be appropriately selected according to the purposes. Examples of the other processes include: drying and removing of the organic solvent in the aqueous ink composition applied on the recording medium; and a thermal fixing in which the resin fine particles or polymer latex contained in the aqueous ink composition are fused to be fixed.

In embodiments, the ink jet recording method employed the invention may employ an intermediate transfer body as an a recording medium on which an image is to be recorded first. Namely, in embodiments, the ink jet recording method employed the invention include: applying, onto an intermediate transfer body, the aqueous ink composition of the invention containing the copolymer, the pigment, the organic solvent, the neutralizer and water, by an ink jet method; applying, onto the intermediate transfer body, the aqueous liquid composition containing a component which makes the pigment in the aqueous ink composition be aggregating, so as to have the aqueous ink composition and the aqueous liquid composition are brought into contact with each other to form an image on the intermediate transfer body; and transferring the thus-formed image on the intermediate transfer body to a recording medium desired as a final recorded media.

The method may further include other processes such as the drying and removing or the thermal fixing in the same manner as those for the above-described method.

### EXAMPLES

The invention is further described with reference to the following examples, but the invention is not limited thereto. Unless otherwise noted, “part” indicates part by mass.

The weight average molecular weight was measured by gel permeation chromatography (GPC). The GPC is carried out with HLC-8020 GPC (manufactured by Tosoh Corporation), three columns (trade name: TSKgel, SUPER Multipore HZ-H, manufactured by Tosoh Corporation, 4.6 mm ID×15 cm), and THF (tetrahydrofuran) as the eluate. The sample concentration was 0.35 weight %, the flow rate was 0.35 ml/min, the sample injection amount was 10 μl, the measurement temperature was 40° C., and an IR detector was used. The calibration curve was prepared using eight samples “standard sample TSK standard, polystyrene”: “F-40”, “F-20”, “F-4”, “F-1”, “A-5000”, “A-2500”, “A-1000”, and “n-propyl benzene” manufactured by Tosoh Corporation.

### Synthesis Example 1

### Synthesis of Mixture of Monomers M-25 and M-27

9.76 parts of 9(10H)-acridone and 5.61 parts of potassium t-butoxy were dissolved in 30 parts of dimethyl sulfoxide, followed by heating to 45° C. 15.26 parts of chloromethylstyrene (trade name: CMS-P, manufactured by AGC SEIMI CHEMICAL CO., LTD., a mixture of meta-body/para-body in a ratio of 50/50 (mol/mol)) was dropped thereto, followed by further heating at 50° C. under stirring for 5 hr. The reaction solution was poured into 200 parts of distilled water under stirring. The resulted precipitate was filtered and washed, and thereby 11.9 parts of a mixture of monomers M-25 and M-27 was obtained.

### Synthesis Example 2

### Synthesis of Mixture of Monomers M-28 and M-29

355.0 g of 1,8-naphthalimide was dissolved in 1500 ml of N-methylpyrrolidone. 0.57 g of nitrobenzene thereto at 25° C. was added thereto, and 301.4 g of DBU (diazabicycloundecene) was further dropwisely added thereto. After stirring the resultant for 30 min, 412.1 g of chloromethylstyrene (trade name: CMS-P, manufactured by AGC SEIMI CHEMICAL CO., LTD., a mixture of meta-body/para-body in a ratio of 50/50 (mol/mol)) was further dropwisely added, followed by further heating at 60° C. under stirring for 4 hr. Then, 2.7 L of isopropanol and 0.9 L of distilled water were added to the reaction solution, followed by cooling to 5° C. under stirring. The resulted precipitate was filtered and washed with 1.2 L of isopropanol, and thereby 544.0 g of a mixture of monomers M-28 and M-29 was obtained.

### Synthesis Example 3

### Synthesis of Resin Dispersant P-1

88 g of methyl ethyl ketone was placed in a 1000-ml three-necked flask equipped with a stirrer and a cooling tube, heated to 72° C. in a nitrogen atmosphere. Into the flask, a solution prepared by dissolving 0.85 g of dimethyl-2,2′-azobisisobutylate, 15 g of the mixture of monomers M-25 and M-27, 10 g of methacrylic acid, and 75 g of ethyl methacrylate in 50 g of methyl ethyl ketone was added dropwise over a period of 3 hours. After completion of the addition, the reaction was continued for further one hour, and then a solution prepared by dissolving 0.42 g of dimethyl-2,2′-azobisisobutylate in 2 g of methyl ethyl ketone was added into the flask, and the solution was heated at 78° C. for 4 hours. The reaction solution thus obtained was reprecipitated twice in excess amounts of hexane, and the precipitated resin was dried to obtain 96.5 g of a copolymer of (M-25 and M-27-mixture)/methyl methacrylate/methacrylic acid (copolymerization ratio [weight ratio]=15/75/10) (resin dispersant P-1).

The composition of the resin dispersant P-1 thus obtained was confirmed by ¹H-NMR. Its weight average molecular weight (Mw) was 49400 as determined by GPC. The acid value of the polymer was 65.2 mgKOH/g as determined by the method described in Japanese Industrial Standard (JIS K 0070:1992).

### Synthesis Example 4

### Synthesis of Resin Dispersants P-2 to P-7

Resin dispersants P-2 to P-7 were synthesized in the substantially same manner as in the synthesis of the resin dispersant P-1, except that the monomer and the amount (weight ratio) of the 15 g of the mixture of monomers M-25 and M-27, the 10 g of methacrylic acid, and the 75 g of ethyl methacrylate were respectively changed as listed in Table 1.

### Comparative Example 1

### Preparation of Dispersion of Resin-Coated Pigment Particles (Dispersion 1)

12 parts of Pigment Red 122 (a magenta pigment, trade name: CROMOPHTAL JET MAGENTA DMQ, manufactured by Ciba Specialty Chemicals), 5.4 parts of the resin dispersion agent P-1, 16 parts of methyl ethyl ketone, 6.3 parts of an aqueous solution of 1 N NaOH and 60.3 parts of ion-exchanged water were mixed, followed by mixing with a disper mill, further followed by dispersing with passing with a dispersing device (trade name: MICROFLUODIZER M-140K, manufactured by Microfluidics; 150 MPa) for eight times. Subsequently, the resulted dispersion was distilled under reduced pressure at 55° C. to remove methyl ethyl ketone, followed by further removing a part of water, so as to provide a dispersion 1 which contains 15 weight % of resin-coated pigment particles.

Measurement of Particle Diameter of Resin-Coated Pigment Particle

The dispersion of resin-coated pigment particles obtained was measured with a NANOTRAC particle size distribution analyzer UPA-EX150 (manufactured by Nikkiso Co., Ltd.) to determine the volume average particle diameter by a dynamic light scattering method. For the measurement, 10 ml of ion exchange water was added to 10 μl of the dispersion of resin-coated pigment particles to make a sample solution, and the temperature of the solution was adjusted to 25° C. The measurement results are listed in Table 1.

Preparation of Latex

19.8 g of LATEMUL ASK (trade name, manufactured by Kao Corporation; carboxylate emulsifier), 6 g of an aqueous solution of sodium hydroxide (5 mol/L) and 0.3 g of 2,2′-azobis(2-amidinopropane) dihydrochloride were added to 120 g of water, followed by homogeneously dissolving.

The solution was then heated at 70° C., and a monomer mixture of 25.9 g of styrene, 26.3 g of butyl acrylate and 5.1 g of acrylic acid was added thereto over 2 hr. Thereafter, the resulted solution was heated at 70° C. for 2 hr and at 80° C. for 3 hr. After the solution was cooled to room temperature, an aqueous solution of 1 mol/L sodium hydroxide was added thereto under stirring so as to make the pH thereof be around 9, thereby a latex PL-01 was obtained.

A volume average particle diameter of the resulted latex was 115 nm. A solid content of the latex dispersion liquid was 33 weight %.

Preparation of Aqueous Ink Composition

An aqueous ink composition having the following formulation was prepared using the dispersion of the resin-coated pigment particles. The aqueous ink composition has a pH of 8.9 at 25° C.

Formulation of Aqueous Ink Composition:

| | | |
|---|---|---|
| Dispersion of resin-coated pigment particles | 30 | parts |
| Latex PL-01 | 8.2 | parts |
| 3 mol of ethyleneoxy group- adduct of solbitol | 5 | parts |
| (SP value: 35.1) | | |
| DPGmBE (SP value: 20.5) | 4 | parts |
| DEGmBE (SP value: 23.7) | 8 | parts |
| Glycerin (SP value: 41.0) | 15 | parts |
| Thiodiglycol (SP value: 31.2) | 2 | parts |
| 1,5-pentanediol | 1 | part |
| OLFIN E1010 (trade name, manufactured by Nisshin | 1 | part |
| Chemical Industry Co., Ltd.) | | |

Ion exchange water: balance (to adjust the total amount of the composition to 100 parts)

Evaluation of Ink Composition

The ink composition obtained as described above was loaded into an inkjet apparatus having prototype print heads each having 600 dpi and 256 nozzles, and the occurrence of white spots was evaluated by the following method. A sheet of TOKUBISHI ART RYOMEN N (trade name, manufactured by Mitsubishi Seishi Co., basis weight: 84.9 g/m²) was herein used as a recording medium.

Evaluation of Curling Suppression

A recording medium having a solid image formed thereon at an ink-coating amount of 5 g/m² was cut into a size of 5×50 mm in a curl direction, followed by leaving under condition of a temperature of 25° C. and humidity of 50% for 24 hr, further followed by observing a curling behavior (curl value: curvature C) to evaluate the curl behavior based on the following evaluation criteria. Evaluation results are shown in Table 2.

Evaluation Criteria

A: The curvature C is 20 or less.

D: The curvature C exceeds 20.

Method for Measuring Curvature

The sample cut into a size of 5×50 mm in a curl direction was applied to a curl measurement plate to read a curl value (C). The curl value is expressed by Equality 1 shown below with assuming a curl of the sample as an arc of a circle having a radius of R.

C=1/R(m) Equality 1

Evaluation of White Spot

The obtained aqueous ink composition was stored at 40° C. for 6 months. After the storage, the aqueous ink composition was jetted from print heads onto a recording medium for 30 minutes. Subsequently, as a maintenance operation, the print heads were subjected to a pressure of 15 KPa for 10 seconds, and wiped with CLEAN WIPER FF-390c (trade name, manufactured by Kuraray Co., Ltd.). Thereafter, ink jetting was restarted and continued for minutes, and an image (5 cm×5 cm) recorded on a recording medium made at 5 minutes after the restart of the printing was observed. The observed image was evaluated based on the following visual observation criteria.

Criteria:
A: No white spot is observed.
B: Two or less white spots are observed.
C: Three to ten white spots are observed.
D: More than ten white spots are observed.

Dispersions 2 to 7

Dispersions of resin-coated pigment particles were prepared and evaluated for the particle diameter in the same manner as in Comparative example 1, except that the resin dispersant P-1 (the copolymer of mixture of monomers M-25 and M-27/methyl methacrylate/methacrylic acid) was changed to any one of the resin dispersants P-2 to P-7 as listed in Table 1. The results of the measurement are listed in Table 1.

### Examples 1 to 4 and Comparative Examples 2 to 6

Preparations and evaluations of aqueous ink composition of Examples 1 to 4 and Comparative examples 2 to 6 were performed in the similar manner as those in Comparative example 1, except that the amount and the dispersion of the resin-coated pigment particle and the water-soluble organic solvent were changed to those shown in Table 2. The results of the evaluations are listed in Table 2.

TABLE 1

| Dispersion of | Copolymer | | | | Particle |
|---|---|---|---|---|---|
| Resin-coated | | Species | Weight Average | Acid Value | Diameter of |
| Pigment Particle | | (Ratio in terms of weight %) | Molecular Weight | (mgKOH/g) | Dispersion (nm) |
| Dispersion 1 | P-1 | Copolymer of {(M-25/M-27) | 49400 | 65.2 | 82 |
| | | Mixture/Ethyl | | | |
| | | Methacrylate/Methacrylic Acid} | | | |
| | | (15/75/10), | | | |
| Dispersion 2 | P-2 | Copolymer of {(M-25/M-27) | 45300 | 97.8 | 80 |
| | | Mixture/Ethyl | | | |
| | | Methacrylate/Methacrylic Acid} | | | |
| | | (15/70/15) | | | |
| Dispersion 3 | P-3 | Copolymer of {(M-25/M-27) | 48200 | 45.6 | 78 |
| | | Mixture/Ethyl | | | |
| | | Methacrylate/Methacrylic Acid} | | | |
| | | (15/78/7) | | | |
| Dispersion 4 | P-4 | Copolymer of {(M-28/M-29) | 38600 | 65.2 | 87 |
| | | Mixture/Ethyl | | | |
| | | Methacrylate/Methacrylic Acid} | | | |
| | | (15/75/10) | | | |
| Dispersion 5 | P-5 | Copolymer of (Benzyl | 46300 | 65.2 | 108 |
| | | Methacrylate/Methacrylic Acid) | | | |
| | | (90/10) | | | |
| Dispersion 6 | P-6 | Copolymer of (Benzyl | 43200 | 130.4 | 115 |
| | | Methacrylate/Methacrylic Acid) | | | |
| | | (80/20) | | | |
| Dispersion 7 | P-7 | Styrene/Methacrylic Acid (90/10) | 38500 | 65.2 | 125 |

TABLE 2

| | Water-soluble Organic Solvent | | | | |
|---|---|---|---|---|---|
| | Formulation (Amount of | | Amount of Water-soluble | | |
| | Water-soluble Organic Solvent | Dispersion of | Organic Solvent having SP | | |
| | based on Total amount of Ink | Resin-coated | Value ≦27.5 in (a) Water-soluble | Evaluation | |
| | (SP Value: weight %)) | Pigment Particles | Organic Solvent (weight %) | Curl | White spot |
| Comparative Example 1 | 3 mole of Ethyleneoxy | 1 | 34 | D | A |
| | Group-adduct of Sorbitol | | | | |
| | (35.1: 5%) | | | | |
| | DPGmBE (20.5: 4%) | | | | |
| | DEGmBE (23.7: 8%) | | | | |
| | Glycerin (41.0: 15%) | | | | |
| | Thiodiglycol (31.2: 2%) | | | | |
| | 1,5-pentanediol (29.0: 1%) | | | | |
| Comparative Example 2 | Diethylene Glycol (30.6: 20%) | 2 | 0 | D | A |
| Comparative Example 3 | Glycerin (41.0: 10%) | 5 | 0 | D | A |
| | Diethylene Glycol (30.6: 5%) | | | | |
| Comparative Example 4 | Glycerin (41.0: 1%) | 5 | 94 | A | D |
| | TEGmBE (21.11: 10%) | | | | |
| | PGmME (23.05: 5%) | | | | |
| Comparative Example 5 | DEGmEE (22.38: 10%) | 6 | 100 | A | C |
| | TEGmBE (21.11: 5%) | | | | |
| Comparative Example 6 | DEGmEE (22.38: 10%) | 7 | 100 | A | C |
| | TEGmBE (21.11: 5%), | | | | |
| Example 1 | DEGmEE (22.38: 10%) | 2 | 100 | A | A |
| | TEGmBE (21.11: 5%) | | | | |
| Example 2 | Glycerin (41.0: 1%) | 1 | | | |
| | TEGmBE (21.11: 10%) | | 94 | A | A |
| | PGmME (23.05: 5%) | | | | |
| Example 3 | 1,2-Hexanediol (27.36: 8%) | 3 | 100 | A | A |
| | TEGmBE (21.11: 5%) | | | | |
| | TPGmME (20.43: 3%) | | | | |
| Example 4 | 1,2-Hexanediol (27.36: 8%) | 4 | 100 | A | B |
| | TEGmBE (21.1: 5%) | | | | |
| | TPGmME (20.43: 3%) | | | | |

As shown in the Table 2, Comparative examples 4 to 6, in which the content of the water-soluble organic solvent having a SP value of 27.5 or less is 90% or more with respect to the total amount of water-soluble organic solvent, show excellent curling suppression characteristics; however, the white spot after time lapse were found therein. On the other hand, Examples 1 to 4 inhibited the jetting direction defects, and white spot defects in a recorded image were suppressed.

The above Examples are exemplary embodiments in which a magenta color ink composition is prepared as the aqueous ink composition. When a species (color) of the pigment used in the magenta color ink composition is changed, aqueous ink compositions having various colors such as a black ink composition, a cyan ink composition or a yellow ink composition may be obtained in a manner similar to the above.

Further, when aqueous inks of two or more colors are charged into an inkjet recording apparatus, a multi-color image may be recorded, and results and advantages which are similar to those mentioned above may be obtained in a manner similar to the above.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink composition comprising:
a pigment;
one or more water-soluble organic solvents;
a neutralizer; and
water,
at least a part of a surface of the pigment being coated with a copolymer comprising a repeating unit represented by the following Formula (1) and a repeating unit having an ionic group, and
the one or more water-soluble organic solvents comprising a water-soluble organic solvent having a solubility parameter value of 27.5 or less at a content of 90 weight % or more with respect to the total content of the one or more water-soluble organic solvents: 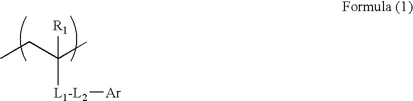
wherein R¹ represents a hydrogen atom or a methyl group; L₁ represents a substituted or unsubstituted phenylene group; L₂ represents a single bond or a divalent linkage group; and Ar represents a monovalent group derived from: a condensed aromatic ring having 8 or more carbon atoms; a hetero ring containing condensed aromatic rings; or two or more linked benzene rings.

2. The ink composition of claim 1, wherein the aromatic ring represented by Ar in Formula (1) is a monovalent group derived from acridone or phthalimide.

3. The ink composition of claim 1, wherein the copolymer comprises a hydrophilic structural unit (A) and a hydrophobic structural unit (B), the hydrophobic structural unit (B) comprises the structural unit represented by Formula (I), the content of the hydrophilic structural unit (A) is 15 weight % or less of the total amount of the copolymer, and the hydrophilic structural unit (A) comprises a structural unit derived from (meth)acrylic acid.

4. The ink composition of claim 1, wherein the copolymer has an acid value of 30 mgKOH/g to 100 mgKOH/g.

5. The ink composition of claim 1, wherein the copolymer has a weight average molecular weight of 30000 or more.
